(19) United States
(12) Patent Application Publication
(10) Pub. No.: US 2015/0317737 A1
(43) Pub. Date: Nov. 5, 2015

(54) SYSTEM AND METHOD OF MANAGING RISK IN AN INVESTMENT FUND

(71) Applicant: Kristopher WALLACE, (US)

(72) Inventor: Kristopher A. WALLACE, St. Louis, MO (US)

(73) Assignee: FS IP LLC, St. Louis, MO (US)

(21) Appl. No.: 14/647,956

(22) PCT Filed: Nov. 27, 2013
(86) PCT No.: PCT/US13/72283

§ 371 Date: May 28, 2015

Related U.S. Application Data
(60) Provisional application No. 61/730,680, filed on Nov. 28, 2012.

(51) Int. Cl. G06Q 40/06

(52) U.S. Cl. CPC G06Q 40/06

(57) ABSTRACT

A method of managing risk in an investment fund is implemented on a computer based system. The method includes (a) determining a primary investment in accordance with a primary investment objective; (b) determining a secondary investment objective that is a financial opposite of the primary investment objective; (c) determining secondary investment in accordance with the secondary investment objective; (d) performing a rebalancing cycle having (i) at a first point, (1) calculating a net asset value of the investment pair according to formula EQ.NAV=(EQ.primary+EQ.secondary); (2) calculating a nominal net asset value according to formula NN.NAV=(HU.primary*PI.market price+EQ.secondary) (3) calculating an actual leverage factor according to formula LF.actual=(NN.NAV/EQ.NAV); (ii) at a second point calculating by a computer of a rebalance trade of the primary investment according to formula RBTR=(EQ.NAV*LF.target−NN.NAV).

### CROSS-REFERENCE TO RELATED APPLICATIONS

This application is a non-provisional counterpart to and claims priority to U.S. Ser. No. 61/730,680, which was filed Nov. 28, 2012, which is pending, and which is incorporated by reference in its entirety for all purposes.

### BACKGROUND OF THE INVENTION

1. Field of the Invention

The present invention is directed to generally to a system and method of managing risk in an investment fund, and more particularly to a computerized system and a computer-implemented method of managing risk in an investment fund that leverages its equity by acquiring a primary investment and a secondary investment that is the financial opposite of the primary investment and rebalancing at least the primary investment periodically due to market moves.

2. Description of the Related Art

Investment funds are powerful tools in the financial marketplace by taking advantage of the pooled resources of multiple investors and professional management. Professional managers set the objectives of the fund and acquire the investments that make up the investment fund.

However, two risks exist for managers and investors alike. The first is that the fund may become insolvent. Typically, pursuant to governing documents and exchange listing agreements, an exchange traded fund will be delisted from its listing exchange, and must cease operation and/or ask for new investments, when the net asset value of the fund is zero. However, practical insolvency may occur when the net asset value of the fund is limited to an amount of capital required to operate the fund for 30-60 days since it may take that long to formally wind down a fund and make distributions to investors.

The second is that the fund strays from its investment objectives. That is, the fund may become over-weighted in one investment area. The realization that the fund has become unbalanced may occur at the most inopportune time and the fund may need to jettison existing investments and/or acquire new investments when the market is unfavorable.

Thus, what is desired is a risk-management method implemented on a risk-management system.

### SUMMARY OF THE INVENTION

These and other needs are met by a pet toy of the present invention.

A system for managing risk in an investment fund includes at least one computer for
executing a first selection to determine a primary investment in accordance with a primary investment objective;
executing a second selection to determine a secondary investment objective that is a financial opposite of the primary investment objective;
executing a third selection to determine a secondary investment in accordance with the secondary investment objective;
performing a rebalancing cycle comprising
   (i) at a first point in time,
      (1) calculating a net asset value of the investment pair according to formula EQ.NAV=(EQ.primary+EQ.secondary);
      (2) calculating a nominal net asset value according to formula NN.NAV=(HU.primary*PI.marketprice+EQ.secondary)
      (3) calculating an actual leverage factor LF.actual according to formula LF.actual=(NN.NAV/EQ.NAV);
   (ii) at a second point in time, the second point in time being subsequent in time to the first point in time, calculating a rebalance trade RBTR of the primary investment according to formula RBTR=(EQ.NAV*LF.target−NN.NAV);
wherein
EQ.primary is an equity of the primary investment;
EQ.secondary is an equity of the secondary investment;
HU.primary is a number of holding units of the primary investment; and
PI.marketprice is a market price per holding unit of the primary investment.

At a third point in time, the third point in time being subsequent in time to the second point in time, the computer executes a trading subroutine to execute the rebalance trade.

A method of managing risk in an investment fund, where the investment fund comprises an investment pair, the investment pair comprising a primary investment and a secondary investment that is the financial opposite of the first investment, the investment fund comprising a target leverage factor LF.target, includes the steps of:
(a) at a first point in time,
   (i) calculating by a computer a net asset value of the investment pair according to formula EQ.NAV=(EQ.primary+EQ.secondary);
   (ii) calculating by a computer a nominal net asset value according to formula NN.NAV=(HU.primary*PI.marketprice+EQ.secondary);
   (iii) calculating by a computer an actual leverage factor LF.actual according to formula LF.actual=(NN.NAV/EQ.NAV);
(b) at a second point in time, the second point in time being subsequent in time to the first point in time, calculating by a computer of a rebalance trade RBTR of the primary investment according to formula RBTR=(EQ.NAV*LF.target−NN.NAV);
wherein
EQ.primary is an equity of the primary investment;
EQ.secondary is an equity of the secondary investment;
HU.primary is a number of holding units of the primary investment; and
PI.marketprice is a market price per holding unit of the primary investment.

The method further includes a step (c) at a third point in time, the third point in time being subsequent in time to the second point in time, executing on a computer a trading subroutine to execute the rebalance trade.

Steps (a), (b) and (c) comprise a single rebalancing cycle, and a plurality of rebalancing cycles are performed consecutively after each other.

A method of managing risk in an investment fund where the investment fund comprises a target leverage factor LF.target, includes the steps of:
(a) executing a first selection on a computer to determine a primary investment in accordance with a primary investment objective;
(b) executing a second selection on a computer to determine a secondary investment objective that is a financial opposite of the primary investment objective;
(c) executing a third selection on a computer to determine a secondary investment in accordance with the secondary investment objective;
(d) performing a rebalancing cycle comprising
   (i) at a first point in time,
      (1) calculating by a computer a net asset value of the investment pair according to formula EQ.NAV=(EQ.primary+EQ.secondary);
      (2) calculating by a computer a nominal net asset value according to formula NN.NAV=(HU.primary*PI.marketprice+EQ.secondary);
      (3) calculating by a computer an actual leverage factor LF.actual according to formula LF.actual=(NN.NAV/EQ.NAV);
   (ii) at a second point in time, the second point in time being subsequent in time to the first point in time, calculating by a computer of a rebalance trade RBTR of the primary investment according to formula RBTR=(EQ.NAV*LF.target−NN.NAV);
wherein
EQ.primary is an equity of the primary investment;
EQ.secondary is an equity of the secondary investment;
HU.primary is a number of holding units of the primary investment; and
PI.marketprice is a market price per holding unit of the primary investment.

The method includes a step (iii) at a third point in time, the third point in time being subsequent in time to the second point in time, executing on a computer a trading subroutine to execute the rebalance trade and wherein step (i) is repeated after step (iii).

### BRIEF DESCRIPTION OF THE DRAWINGS

FIG. 1 is a schematic diagram of a system for managing risk in an investment fund in accordance with one or more embodiments of the present invention.

FIGS. 2a-2b are flowcharts of a method of managing risk in an investment fund in accordance with one or more embodiments of the present invention.

FIGS. 3a-3d are spreadsheets illustrating a first example of the method of the present invention in accordance with one or more embodiments of the present invention.

FIG. 4 is a spreadsheet illustrating a second example of the method of the present invention in accordance with one or more embodiments of the present invention.

FIG. 5 is a spreadsheet illustrating a third example of the method of the present invention in accordance with one or more embodiments of the present invention.

### DETAILED DESCRIPTION OF THE INVENTION

In the following description, reference is made to the accompanying drawings that form a part of the present application. The drawings show one or more embodiments in which the invention may be practiced. It is to be understood that other embodiments may be utilized and changes may be made without departing from the scope of the present invention.

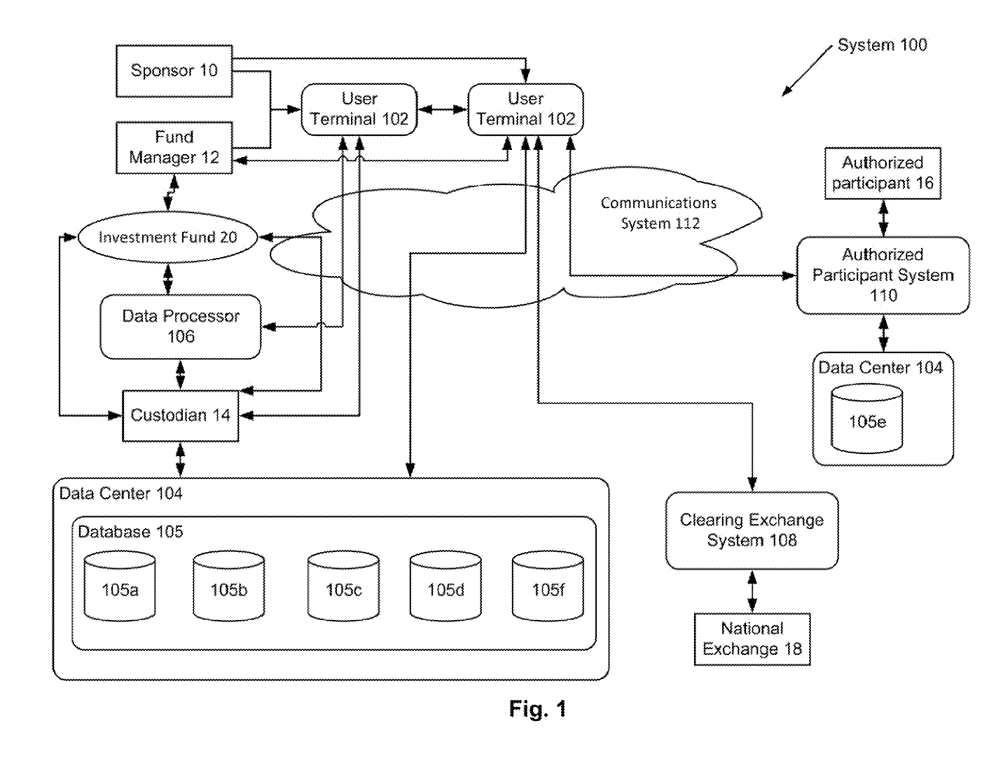

FIG. 1 is a schematic diagram of a system for managing risk in an investment fund in accordance with one or more embodiments of the present invention.

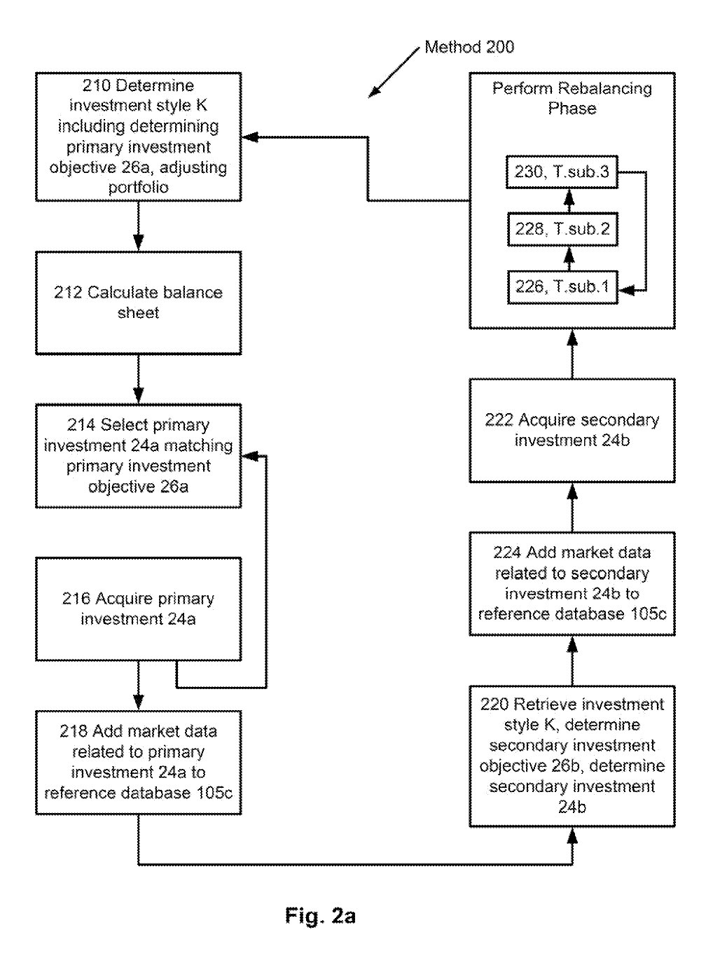

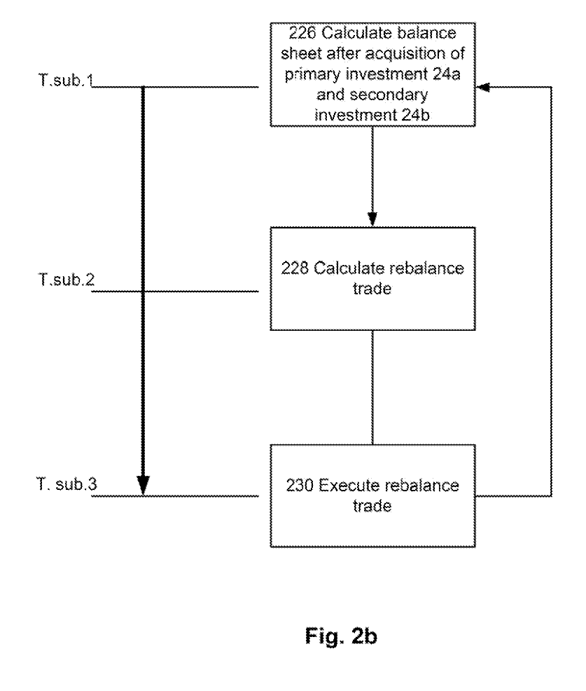

FIGS. 2a-2b are flowcharts of a method of managing risk in an investment fund in accordance with one or more embodiments of the present invention.

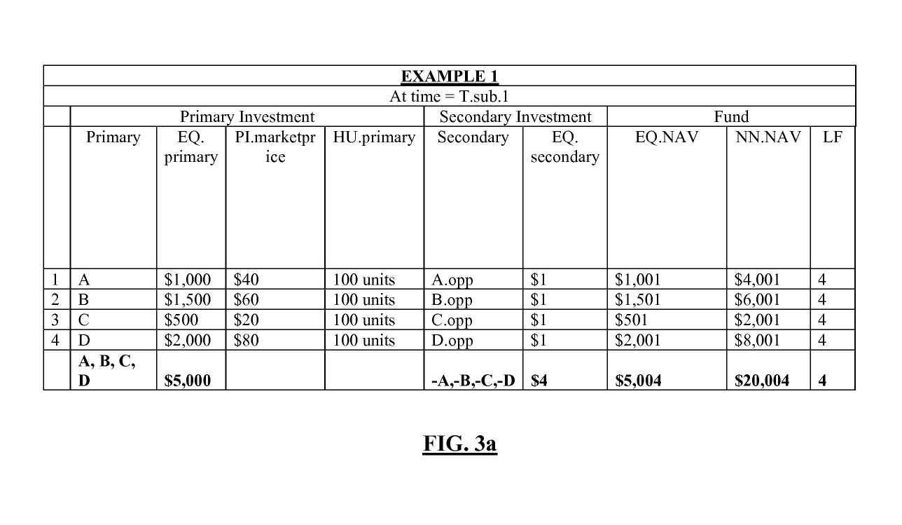

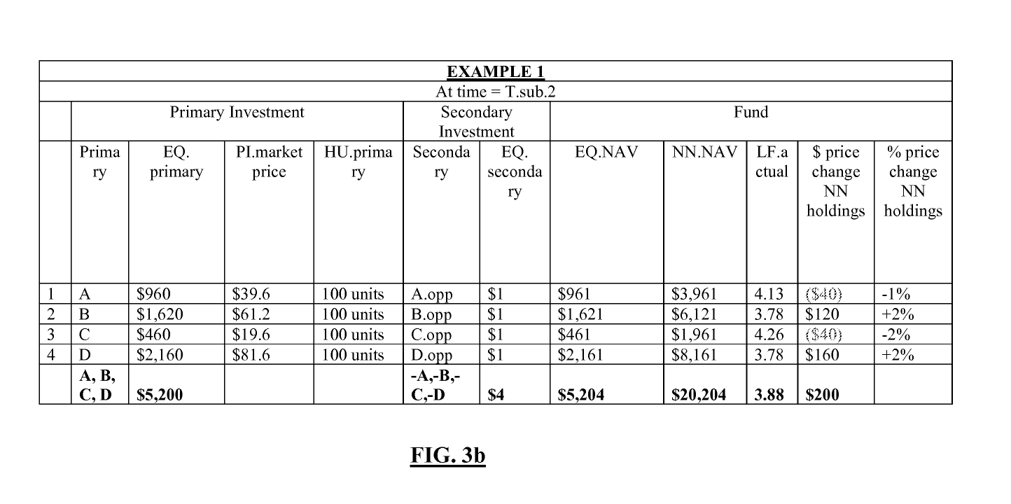

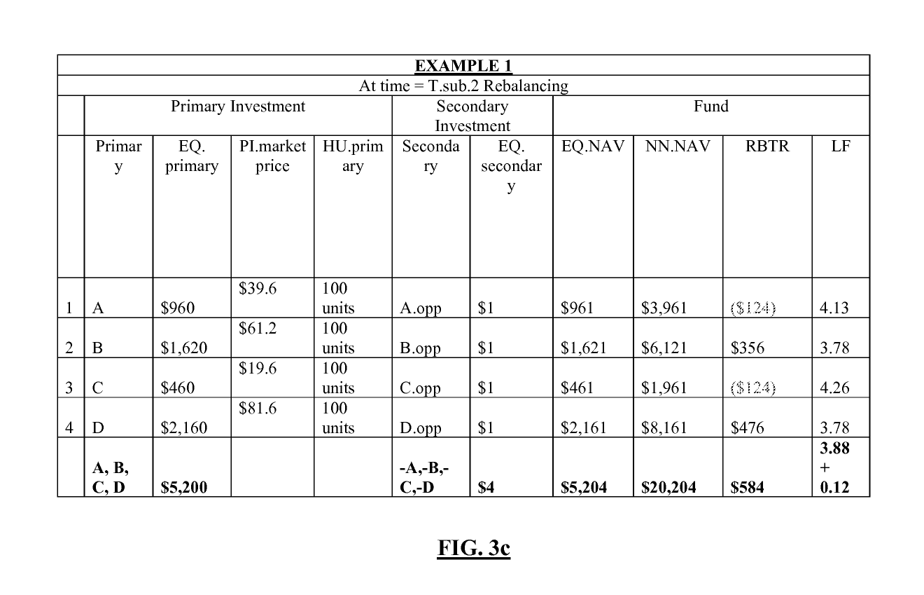

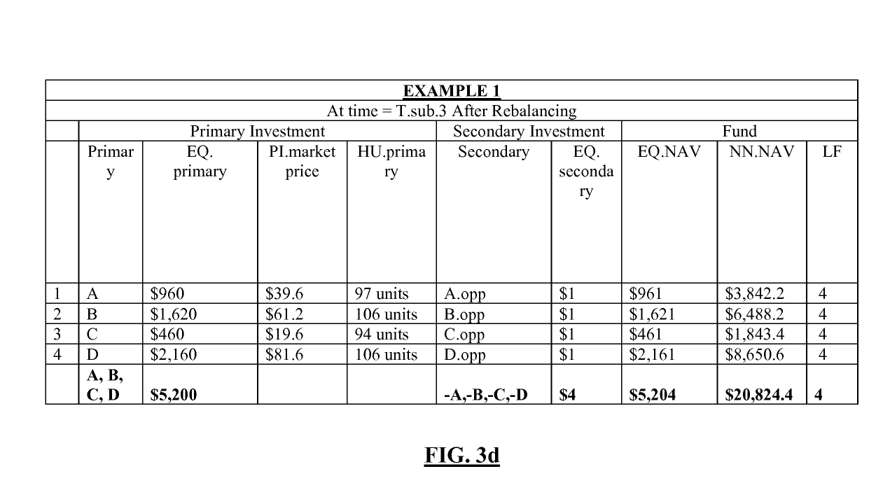

FIGS. 3a-3d are spreadsheets illustrating a first example of the method of the present invention in accordance with one or more embodiments of the present invention.

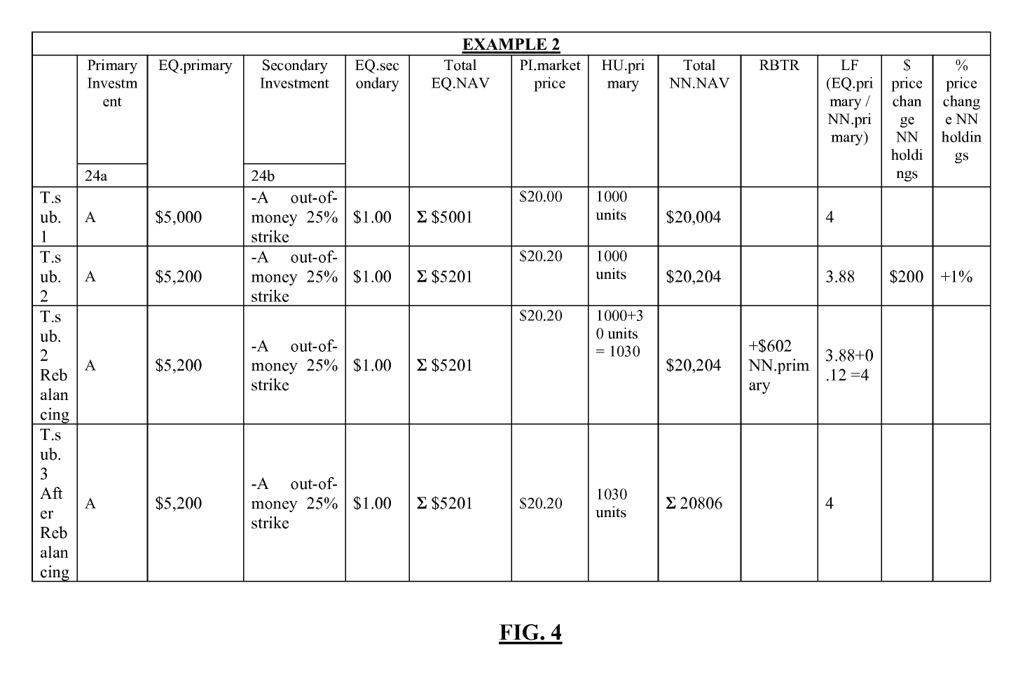

FIG. 4 is a spreadsheet illustrating a second example of the method of the present invention in accordance with one or more embodiments of the present invention.

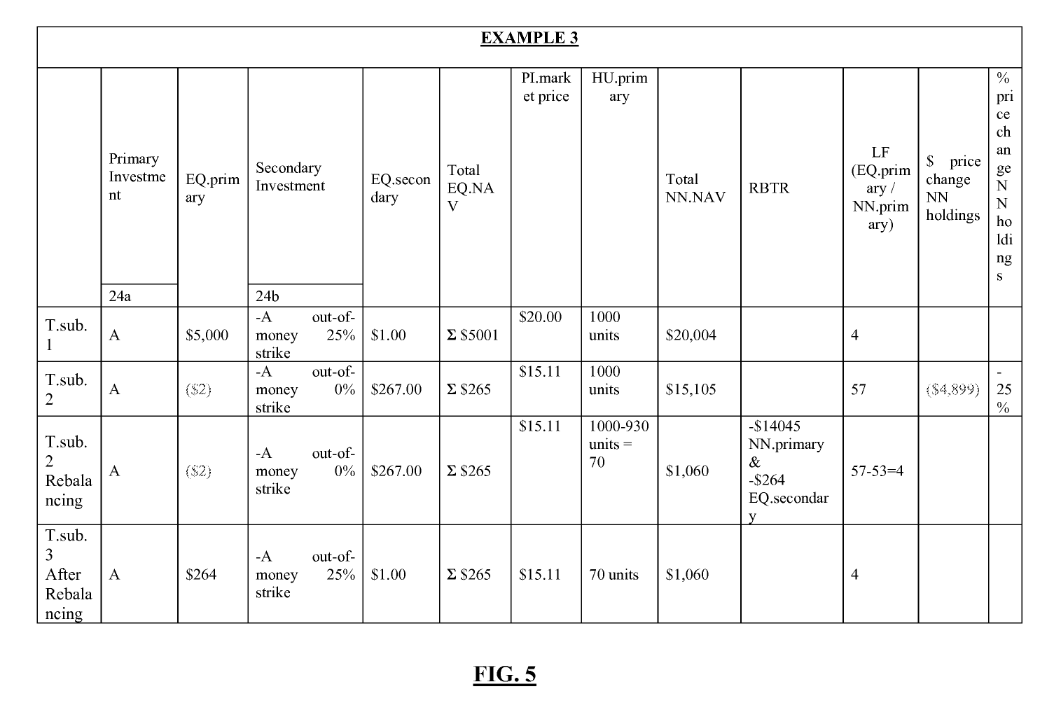

FIG. 5 is a spreadsheet illustrating a third example of the method of the present invention in accordance with one or more embodiments of the present invention.

In accordance with one or more embodiments of the present invention, at least one sponsor 10 promulgates, operates, conducts, manages, directs, instructs, controls, and/or is associated with investment fund 20 and hedges investment fund 20 against one or more risks R using a risk-management method 200 implemented on a risk-management system 100.

Sponsor 10 may employ one or more fund managers 12, one or more custodians 14, one or more authorized participants 16, one or more national exchanges 18, each of which may comprise one or more users of system 100 and/or method 200.

“User” is intended in this application for all purposes to be interpreted broadly and is defined to be one or more individuals, such as directors, managers, employees, trader, contractors and/or the like, one or more functional groups, such as a management committee, compliance department, accounting department, marketing department, trading desk, and/or the like, and/or anyone or any group that has a need to interface, interact, and/or access the investment fund and with another user in the system and/or method.

Custodian 14 holds in safekeeping assets/securities such as stocks, bonds, commodities such as precious metals and currency (cash), domestic and foreign; arranges settlement of any purchases and sales and deliveries in/out of such securities and currency; collects information on and income from such assets (dividends in the case of stocks/equities and coupons (interest payments) in the case of bonds) and administers related tax withholding documents and foreign tax reclamation, administers voluntary and involuntary corporate actions on securities held such as stock dividends, splits, business combinations (mergers), tender offers, bond calls, etc.; provides information on the securities and their issuers such as annual general meetings and related proxies; maintains currency/cash bank accounts, effect deposits and withdrawals and manage other cash transactions; performs foreign exchange transactions; perform additional services for sponsor 10 which may include fund accounting, administration, legal, compliance and tax support services.

Custodian 14 may be a custodian bank that is a global custodian and safe keeps assets for investment fund 20 in multiple jurisdictions around the world, using their own local branches or other local custodian banks with which custodian 14 contracts to be in their “global network” in each market to hold accounts for investment fund 20.

An authorized participant 16, who must be broker-dealers or other participant in a clearing process through one or more registered clearing corporations, sells one or more shares S on the open market for fund manager 12, and/or interfaces on behalf or instead with a national exchange 18 for sale of the shares and/or investments in investment fund 20.

Investment fund 20 may have the form of any legally permissible fund and is preferably at all times in compliance with all necessary laws and with trust instruments. These laws are the Securities Act of 1933 (15 U.S.C. §77a et seq.) (as amended through P.L. 112-106, approved Apr. 5, 2012, the “Securities Act”), the Securities Exchange Act of 1934 (15 U.S.C. §78a et seq.) (as amended through P.L. 112-158, approved Aug. 10, 2012, the “Exchange Act”) and, if applicable, the Investment Company Act of 1940 (15 U.S.C. §80a-1 et seq.) (as amended through P.L. 112-90, approved Jan. 3, 2012, the “Investment Company Act”).

Preferably, as illustrated by the embodiments of this application, investment fund 20 is an exchange-traded fund. However, investment fund 20 may have other fund forms including that of an open-ended fund without departing from the spirit of the invention.

Investment fund 20 is divided into a plurality of shares S for which a net asset value NAV is calculated on a regular or irregular basis and, as is common with an open-ended fund, is preferably actively managed by fund manager 12. One or more shares S may be aggregated in creation units that are provided to institutional investors for sale to one or more retail investors.

One or more investors, i.e., shareholders H, are owners of one or more shares S of investment fund 20 and may also be users of system 100 and/or method 200. One or more shares S may also be held and/or redeemed by sponsor 10 and/or fund manager 12 as compensation for managing investment fund 20. Moreover, one or more shares may also be undistributed and be held by investment fund 20 as an asset of the investment fund 20. Thus, for certain purposes, sponsor 10, fund manager 12, and/or investment fund 20 may also be shareholders.

Investment fund 20 comprises one or more primary investments 24a selected according to risk-management method 200 for one or more primary investment objectives 26a and one or more secondary investments 24b selected according to risk-management method 200 for one or more secondary investment objectives 26b to hedge investment fund 20 against one or more risks R. Therein, the one or more secondary investments selected to be the financial opposite of the one or more primary investment and the one or more primary investments are collectively an “investment pair.”

“Financial opposite” is intended in this application for all purposes to be interpreted broadly and is defined as a financial objective or investment that directly or indirectly responds as a hedge against another financial objective or investment, respectively and may also be defined by example as when a secondary investment objective provides the fund to put/call the equivalent of the primary investment objective, in whole or in part, to/from a counterparty, at a specified strike price, for the purpose of offsetting the investment exposure of the primary investment objective at such specified strike price.

The one or more primary investment objectives 26a may be selected based on preselected product development criteria and defined in a fund's prospectus. The primary investment 24a has a financial movement M; the primary investment may be any suitable investment but preferably is a leveraged investment, as defined below.

“Leveraged investment” is intended in this application for all purposes to be interpreted broadly and is defined as an investment that comprises an invested equity portion that is amplified, magnified, or increased through the use of one or more contractual arrangements, one or more debt obligations, and/or other legal and/or financial devices. A leveraged investment increases the risk to an investment fund 20 since both gains and losses are amplified.

Therein, a leveraged investment preferably has an equity value EQ, a nominal net value NN, and a leverage factor LF. For example, at its most simplistic, a $1000 cash investment in a leveraged investment has an equity value EQ of $1000 and a nominal net value NN of $3000. It also has leverage factor LF of 3, that is the investment is leveraged three times, $3000 nominal value/$1000 equity value. A leverage factor of 3 can also be expressed as a leverage of 300%, but in this application numerical values rather than percentages are used. It should be understood where a numerical value is given a percentage may also be used.

Although certain leveraged investment may be traded in fractional dollar values, most leveraged investments comprise one or more holding units (“holding units”) HU denominated in a fixed dollar value, i.e., face value. During the leveraging period, i.e., contract period, the investment may be bought and sold at a “market price” set by a clearing body, i.e. national exchange or investment bank and the market price may differ from the face value due to one or more underlying market conditions that may be responsive to and/or reflective of one or more risks R.

In an Example A, a leveraged investment comprises a plurality of holding units HU and each unit is denominated in $250 face value. If investment fund 20 acquires 20 holding units for $2000 equity, i.e., a market price of $100 per unit. Thus, the leverage factor is 2.5 since 20 units*$250/unit have a nominal value of $5000 and $5000 nominal value/$2000 equity yields a leverage factor of 2.5.

Therein, primary investment 24a may include current contracts acquired through national exchanges 18 or, when available, contracts acquired off national exchanges, specifically Futures Contracts, Forward Contracts, Swaps, Equity Positions, Mutual Funds, ETF Funds, ETPs, Fixed Income Positions, Derivatives, Put/Call positions.

Table I provides by example but not by limitation a listing of primary investment objectives 26a and the exemplary primary investments 24a meet those objectives. One skilled in the art would be able to determine other primary investment 24a that would match requisite primary investment objective 26a.

TABLE I
List of Primary Investment Objectives
and Exemplary Primary Investments

| | Primary | Exemplary |
|---|---|---|
| | Investment | Primary |
| | Objective 26a | Investment 24a |
| 1. | S&P 500 | S&P 500 Futures, E-mini S&P 500 Futures, |
| | | Swaps, Forward Contracts, ETP's with S&P 500 |
| | | investment objective, Mutual Funds with S&P |
| | | 500 investment objective |
| 2. | Short S&P 500 | Short S&P 500 Futures, E-mini S&P |
| | | 500 Futures, Swaps, Forward Contracts, ETP's |
| | | with S&P 500 investment objective, Mutual |
| | | Funds with S&P 500 investment objective |
| 3. | DJIA | DJIA ($10) Futures, E-mini Dow ($5) Futures, |
| | | Swaps, Forward Contracts, ETP's with DJIA |
| | | investment objective, Mutual Funds with DJIA |
| | | investment objective |
| 4. | Oil | Crude Oil Futures, Swaps, Forward Contracts, |
| | | ETP's with Oil investment objective, Mutual |
| | | Funds with Oil investment objective |
| 5. | Gold | Gold Futures, Swaps, Forward Contracts, ETP's |
| | | with Gold investment objective, Mutual Funds |
| | | with Gold investment objective |

Therein, secondary investment objective 26b is a financial opposite of one or more primary investment objectives 26a when a preselected product development criteria and defined in a fund's prospectus. A secondary investment objective 26b is a financial opposite of one or more primary investment objectives 26a when the secondary investment objective 26b provides the fund to put/call the equivalent of the primary investment objective, in whole or in part, to/from a counterparty, at a specified strike price, for the purpose of offsetting the investment exposure of the primary investment objective at such specified strike price. In particular, the secondary investment objective protects the investment fund's net asset value from catastrophic events such as going from positive to negative and/or approaching zero due to a massive unfavorable market move.

For example, a secondary investment objective to a combination of contracts may be a combination of put/call holdings. These holdings for the one or more secondary investment objectives 26b may include current contracts acquired through national exchanges or, when available, contracts acquired off national exchanges, specifically Futures Contracts, Forward Contracts, Swaps, Equity Positions, Mutual Funds, ETF Funds, ETPs, Fixed Income Positions, Derivatives, Put/Call positions.

Herein, a “swap” has the common meaning, but may also mean a financial instrument, i.e., derivative contract, whereby one or both counterparties deliver to the other counterparty the performance, return or income relating to a specified asset or benchmark, e.g., a securities index, commodity price, etc. Investment fund 20 intends to use either commodity swaps in which case the counterparties exchange the performance of a floating price of a commodity against a fixed price over a specified period of time, or total return swaps in which case one counterparty will pay to the other the performance of an asset or benchmark in exchange for periodic payments, and in either case to achieve the stated leverage of a primary investment objective.

Herein, a “put option” has the common meaning, but may also mean a contract whereby the purchaser of a put option, e.g., investment fund 20, receives, in exchange for a purchase price paid at the acquisition of the put option, the right but not the obligation to sell to the counterparty a specified asset at a specified strike price. Therein, the put options have an expiration date, after which time they are no longer effective.

Herein, a “call option” has the common meaning, but may also mean a contract whereby the purchaser of a call option, e.g., investment fund 20, receives, in exchange for a purchase price paid at the acquisition of the call option, the right but not the obligation to purchase from the counterparty a specified asset at a specified strike price. Therein, the call options have an expiration date, after which time they are no longer effective.

Investment fund 20 may comprise one or more Put Options and/or Call Options as one or more secondary investments 24b as financial opposites to one or more primary investments 24a and/or as secondary investment objective 26b as financial opposites to one or more primary investment objective 26b.

Table II also provides by example but not by limitation a listing of primary investment objectives 26a and the secondary investment objectives 26b that are the financial opposite to the requisite primary investment objective 26a. One skilled in the art would be able to determine other secondary investment objectives 26b that would be the financial opposite of requisite primary investment objective 26a.

TABLE II
List of Primary Investment Objective and the Secondary
Investment Objective that are the Financial Opposite
to the Primary Investment Objective

| | Primary | Secondary |
|---|---|---|
| | Investment | Investment |
| | Objective 26a | Objective 26b |
| 1. | S&P 500 | S&P 500 inverse |
| 2. | Short S&P 500 | Short S&P 500 inverse |
| 3. | DJIA | DJIA inverse |
| 4. | Oil | Oil inverse |
| 5. | Gold | Gold inverse |

The one or more secondary investment 24b may be selected based on a financial movement M.opposite that is the opposite to financial movement M of primary investment 24a. Secondary investment 24b may be any suitable investment and may also be a leveraged investment (defined above).

Table III provides by example but not by limitation a listing of secondary investment objectives 26b and the exemplary secondary investments 24b meet those objectives. One skilled in the art would be able to determine other secondary investments 24b that would match requisite secondary investment objectives 26b. Thus, the secondary investment in Table III is the financial opposite of the primary investment in Table I on the same row and the two are investment pairs.

TABLE III
List of Primary Investment Objectives and Corresponding
Exemplary Secondary Investments

| | Secondary | Exemplary |
|---|---|---|
| | Investment | Secondary |
| | Objective 26b | Investment 24b |
| 1. | S&P 500 inverse | S&P 500 Puts, Forward Contracts, Swaps |
| 2. | Short S&P 500 inverse | S&P 500 Calls, Forward Contracts, Swaps |
| 3. | DJIA inverse | DJIA Puts, Forward Contracts, Swaps |
| 4. | Oil inverse | Oil Puts, Forward Contracts, Swaps |
| 5. | Gold inverse | Gold Puts, Forward Contracts, Swaps |

The one or more risks R may primarily be or be associated with a negative change of asset values of the one or more primary investment 24a or of a net asset value approaching to zero. When investment fund 20 has a net asset value of zero or less than zero, investment fund 20 must dissolve.

Risk R may also refer or be associated with reputational risks and/or social, political, legal, and/or environmental risks associated with a particular primary investment 24a or with a plurality or all primary investments 24a in investment fund 20.

A system 100 is configured for managing risk R in investment fund 20 in accordance with one or more embodiments of the present invention. A method 200 is a risk management method implemented through system 100, and, thus, method 200 is a computer-implemented method of managing risk R in investment fund 20.

System 100 comprises a plurality of user terminals 102, one or more data centers 104, one or more data processors 106, one or more clearing exchange systems 108, and one or more authorized participant systems 110 interconnected via one or more communications networks 112, collectively or singularly “system participants.”

One or more user terminals 102 may be any kind of suitable computing device capable of accessing system 100, transacting one or more full or partial steps of method 200, monitoring one or more steps of method 200, retrieving data related to method 200, authorizing in part or in full one or more steps of method 200, supervising one or more other user terminals 102, acting as a back-up to another user terminal 102, performing accounting related to one or more investments of investment fund 20, retrieving data related to investment fund 20, and/or being used in any other suitable function related to investment fund 20, system 100, and/or method 200.

Preferably, user terminal 102 is used by one more persons associated with sponsor 10 or, more preferably, fund manager 12. However, user terminal 102 need not have a user, i.e., a person at any time, actively or passively using the terminal, be capable of being used by a person at any time, and/or have any human interface device connected thereto. User terminal 102 may preferably be a personal computer, a laptop, a tablet computer, a smartphone, and/or any other suitable device.

Therein, “computing device” is intended in this application for all purposes to be interpreted broadly and is defined for all uses, all devices, and/or all system participants of system 100 in this application as a device comprising at least a central processing unit that carries out the instructions of one or more computer programs P associated with method 200 by performing arithmetical, logical, and input/output operations to accomplish in whole or in part one or more steps of method 200; a communications device for interfacing with a data network such network 112 and/or interfacing with system 100 and/or one or more system participants; and/or a non-transitory memory such as a hard drive, solid state drive, compact disk drive, and/or DVD drive for storing the one or more computer programs P.

One or more data centers 104 may comprise a plurality of databases 105 comprising data associated with investment fund 20, system 100, and/or method 200 on one or more non-transitory media such as a hard drive, solid state drive, compact disk drive, and/or DVD drive. As is necessary, each non-transitory media may be associated with one or more computing devices. Moreover, one or more databases may be stored to be redundant on multiple non-transitory media and any single database may be stored on a plurality of non-transitory media using RAID database architecture. One or more databases may also be configured to any suitable database architecture such as relational database architecture, non-relational database architecture, hierarchical architecture, object modeling architecture, and/or core architecture data model.

The one or more databases 105 include one or more shareholder databases 105a, one or more fund holding databases 105b, one or more reference databases 105c, one or more trade databases 105d, one or more authorized participant databases 105e, and one or more compliance databases 105f.

Each shareholder database 105a comprises one or more data detailing and/or associated with a current, past, and/or prospective account information for one or more shareholders of investment fund 20 and and/or current, past, and/or prospective information regarding trades, acquisitions, creations, and/or redemptions undertaken by the one or more shareholders. Moreover, each shareholder database 105a comprises one or more data detailing and/or associated with an audit trail of the shareholder information.

Each fund holding database 105b comprises one or more data detailing and/or associated with prospective information regarding trades undertaken by investment fund 20; current, past, and/or prospective redemptions; and all other necessary data to manage investment fund 20 including current, past, and/or prospective net asset value of the investment fund 20; all data related to primary investment 24a matching primary investment objective 26a, and all data related to secondary investment 24b matching secondary investment objective 26b.

Each reference database 105c comprises one or more data detailing and/or associated with market data MD of the primary investment 24a and secondary investment 24b. Market data MD may be any suitable information for understanding primary investment 24a and secondary investment 24b. Market data MD may be expiration dates, contract specifications for investments comprising such contracts, holdings unit value, primary investment market price, whether the contracts are negotiated, meet general industry guidelines, and/or pro-forma, or may be security prices of traded equities; and/or any other requisite data.

Preferably, market data MD comprises the units of any leveraged investment. Thus, with respect to Example A above, the market data MD for the leveraged investment preferably comprises “units=16”, “nominal net value per unit=$250”, “acquisition equity=$1600”, and/or “leverage factor—2.5.”

Each trade database 105d comprises one or more data detailing and/or associated regard to one or more acquisitions, sales, and/or rebalance trades made with respect to one or more primary investments and/or one or more secondary investments.

Each authorized participant database 105e comprises one or more data detailing and/or associated with one or more activities performed by an authorized participant.

Each compliance database 105f comprises legal, financial, and/or any other compliance data in regard to one or more primary investments and/or one or more secondary investments especially with regard to timing, size, requirements, and/or conditions of sales and/or acquisitions of the primary investments and/or secondary investments, regulatory requirements, and/or financial requirements that individually or collectively are the rules of investment fund 20.

One or more data processors 106 may be any kind of suitable computing device capable of accessing and/or interacting with one or more data centers 104 and more specifically accessing and/or interacting with one or more databases 105 and executing in part or in full one or more steps of method 200. Moreover, one or more data processors 106 also preferably is capable of accessing system 100, monitoring one or more steps of method 200, retrieving data related to method 200, authorizing in part or in full one or more steps of method 200, interacting with one or more other user terminals 102, acting as a back-up to another data processor 106, performing accounting related to one or more investments of investment fund 20, retrieving data related to investment fund 20, and/or be capable of being used in any other suitable function related to investment fund 20, system 100, and/or method 200. User terminal 102 need not have a user, i.e., a person at any time, using the terminal, be capable of being used by a person at any time, and/or have any human interface device connected thereto.

One more clearing exchange systems 108 may be a system operated by, under the control, of, and/or has been permitted by one or more national exchanges 18 and transacts business one or more system 100.

One or more authorized participant systems 110 may be a system operated by, under the control, of, and/or has been permitted by one or more authorized participants and transacts business on system 100.

Each communications network 112 may be a wired system, a wireless system, a cellular system, a telephone network, a local area network, a wide area network, the Internet, a proprietary data network, a direct wire connection, a router-assisted network, a laser data network, a combination of the foregoing, and/or any other suitable data transmission network for receiving and sending data to one or more data processors, data bases receiving and sending data between and/or among one or more system participants. Each communications network 112 may comprise one or more computing devices configured suitably, such as a router, repeater, or the like, to facilitate or ensure communications and/or data flow.

Method 200 is a risk management method that is implemented through system 100 for managing risk R in investment fund 20. Method 200 may be implemented through the one or more computer programs P stored in the one or more non-transitory media of the computing devices of system 100. Method 200 may be performed once for investment fund 20 or more preferably performed cyclically and/or periodically.

Although each step of method 200 below is described as being performed by at least one subroutine of computer program P on one or more computers, it should be understand that one or more or all subroutines can be combined into one or more computer programs, a program suite, or an enterprise suite and be stored on one or more non-transitory media, such as a hard drive, solid state drive, compact disk, a DVD, or the like. Moreover, the performance of each subroutine by a computer requires that the computer perform one or more arithmetic calculations specific to that step, perform one or more rule-based selection or any other suitable selection.

Herein, “rule-based selection,” “selection,”, and/or “determination” are intended in this application for all purposes to be interpreted broadly and may include selection or determination based on hierarchical rules; non-hierarchical rules; artificial intelligence; calculated data; statistical calculations; financial data calculations such as yield calculations; accounting calculations; accounting assessments; and/or a combination of one or more of these. In a preferred embodiment, a rule-based selection uses a combination of hierarchical rules and accounting calculations to make a selection of one or more investments and/or a ranking of one or more investments.

At one or more steps or preferably each step of method 200, the requisite subroutine of that step performs one or more compliance subroutines. A “compliance subroutine” is intended in this application for all purposes to be interpreted broadly and is defined as subroutine executing on a user terminal 102 and/or a data processor and establishes a connection between the user terminal 102 and/or data processor 106 and compliance database 105f; retrieves legal, financial, and/or any other compliance data responsive to one or more primary investments and/or one or more secondary investments especially with regard to timing, size, requirements, and/or conditions of sales and/or acquisitions of the primary investments and/or secondary investments, regulatory requirements, and/or financial requirements; executes one or more rule-based selection or any other suitable selection, statistical calculations, financial data calculations such as yield calculations, and/or accounting calculations and/or accounting assessments; and determines whether one or more sales, acquisitions, and/or continued holding of one or more primary investment and/or secondary investments are in compliance with the rules of investment fund 20. When one or more primary investments and/or secondary investments are in violation of the rules of the investment fund 20, compliance subroutine brings the investment fund within the rules by executing, if necessary, in conjunction with the trading subroutine, described below, one or more sales, acquisitions, and/or continued holdings of one or more primary investment and/or secondary investments.

In a step 210 of method 200, fund manager 12 determines one or more investment styles K of investment fund 20 and enters the data associated with the investment style into one or more databases 105 and/or adjusting the portfolio of investment fund 20 by determining one or more primary investments, one or more secondary investment, and/or investment pairs to be sold.

Each investment style K may comprise the particularities of the investment fund to address one or more market risks R and will make determinations with respect to the selection, exclusion, inclusion and/or ranking of one or more primary investment 24a, primary investment objective 26a, secondary investment 24b, and secondary investment objective 26b. For example, although, a particular investment objective may meet the criteria set forth above to be a primary investment 24a, the fund manager may exclude it for any reason as primary investment 24a to be used in investment fund 20 via investment style K.

Thus, investment style K may be embodied as a rule-based subroutine, a file, a reference table listing or database that includes, excludes, or ranks these types of investments and/or objectives, makes one or more conditional rules, or in some other way calculates, determines, and/or indicates preference, acceptance, or denial with respect to one or more primary investment 24a, primary investment objective 26a, secondary investment 24b, and secondary investment objective 26b. Investment style K may be stored in a database 105 in data center 104.

Investment style K also comprises a target leverage factor LF.target and/or a leverage factor range LFR that is to be used with respect to primary investment 24a in investment fund 20. Leverage factor LF.target may be any suitable leverage factor LF. Therein, in general a leverage factor LF and movement M are related as follows:

LF=1/M
where M is expressed in a fraction.

A target leverage factor LF.target 3 or greater than 3 is preferred due to the statistical probability that an objective used in a leveraged investment can have a daily move of a positive or negative return of 0 to 100% which would be magnified within investment fund 20. A target leverage factor LF.target of 4, i.e., 4.0, is preferred because it represents a 25% movement M in primary investment 24a.

Leverage factor range LFR may be any suitable range. However, leverage factor range LFR is preferably 3.95-4 in a first embodiment, 3.5-4.4 in a second embodiment, and 4.5-5.4 in a third embodiment, 5.5-6.4 in a fourth embodiment, and 6.5-7.4 in a fifth embodiment and 7.5-8.4 in a sixth embodiment and 8.5-9.4 in a seventh embodiment and 9.5-10.4 in an eighth embodiment.

A leverage factor range LFR of 3.95-4 is most preferred because the range bounds a 25% movement of the primary investments. A leverage factor range LFR of 4.5-5.4 is second most preferred because the range bounds a 20% movement of the primary investments. A leverage factor range LFR of 5.5-6.4—is third most preferred because the range bounds a 16.7% movement of the primary investments. The other leverage factors are considered preferential because they have a particular percentage related to the range as indicated in Table IV.

TABLE IV
Relationship between LFR and M

| Leverage Factor | Movement M in |
|---|---|
| Range LFR | percent bounded by LFR |
| 6.5-7.4 | 14.3% |
| 7.5-8.4 | 12.5% |
| 8.5-9.4 | 11.1% |
| 9.5-10.4 | 10% |

A leverage factor range LFR less than 3.0 is not preferred, because of the statistically likely occurrence would be so low that the cost to execute the protection would not be worth the expense to investment fund 20.

It should be understand that one investment fund 20 may have multiple investment styles K that may be changed as the fund is operated, i.e., a step of replacing an investment style K1 with an investment style K2. One investment fund 20 may have a plurality investment styles K, where one style is used when a first market risk R or predominates, and one or more other investment styles K that are used when other market risks R exist.

In step 210, one or more primary investments 24a and secondary investments 24b may be determined to be sold, i.e., the portfolio of investment fund is adjusted, because they no longer meet investment style K, primary investment objective 26a, and/or secondary investment objective 26b and/or for any other reason. The one or more primary investments, one or more secondary investment, and/or investment pairs to be sold are then sold preferably using a trading subroutine in step 210 or alternatively in step 216.

In a step 212, a subroutine P212 calculates on a user terminal 102 and/or on a data processor 106 as disclosed with respect to step 228 herein the balance sheet of at least one or more of the following or retrieves from a database the balance sheet calculated in step 228 having at least one or more of the following:
the value of all primary investments 24a EQ.primary;
the value of all secondary investments 24b EQ.secondary;
liabilities L
the net asset value EQ.NAV,
the change in the net asset value ΔNAV over a pre-determined period of time T;
any redemptions;
any inflowing investment;
the nominal value of the primary investments;
the holdings unit value of the primary investments;
the nominal value of the secondary investments;
the leverage factor of each primary investment; and
the leverage factor of the sum of the primary investments.

In a step 214, a subroutine P214 retrieves investment style K and performs on user terminal 102 a rule-based selection or any other suitable selection routine to determine one or more primary investments 24a matching one or more primary investment objectives 26a for investment fund 20. Therein, the one or more primary investment objectives match investment style K and may be then selected by the fund manager 12 from several choices. The one or more primary investment objective 26a may instead or in addition be selected and/or presented as the most preferable choice by subroutine P214 in accordance with one or more rules established in step 210.

When more than one distinct primary investment objective 26a exists, subroutine P214 may group the primary investment objectives 26a and acquire one or more primary investment 24a that match the same primary investment objective. For example, the primary investment objectives include a short-term objective and a long-term objective. The short-term primary investment objective is realized as a primary investment in one or more close-to-expiration futures contracts. In contrast, the long-term primary investment objective is realized as a primary investment in one or more futures contracts with one or more longer expirations.

For clarity, the acquisition of only one primary investment 24a with respect to one primary investment objective 26a is described herein. However, more than one primary investment objective 26a may be met by acquisition and/or holding of a single primary investment 24a. Similarly, a single primary investment objective 26a may be met by the acquisition and/or holding of a plurality of primary investments 24a.

In a step 216, a subroutine P216 executes on user terminal 102 and/or data processor 106 to acquire primary investment 24a of step 214 in exchange for equity EQ.primary. Subroutine P216 preferably, but not necessarily, executes one or more trading subroutines in an attempt to acquire the primary investments through clearing exchange system 108 of national exchange 18 or any other suitable source for obtaining the one or more primary investments.

A “trading subroutine” is intended in this application for all purposes to be interpreted broadly and is defined as subroutine executing on a user terminal 102 and/or a data processor and establishes a connection between the user terminal 102 and/or data processor 106 and one or more clearing exchange 108, formats the trading data the investment that is being acquired or sold, and submits the formatted trading data to acquire the investment. The trade is preferably settled in accordance with established industry procedure.

If unsuccessful, subroutine P214 repeats step 214 to select or determine other primary investments that the meet primary investment objectives and attempts to acquire these primary investments and then proceeds to step 216.

If successful, in step 218, a subroutine P218 executes on user terminal 102 and adds data associated with the acquisition of the one or more primary investment 24a into fund holding database 105b. Such data may be the number of shares or holding units acquired, the date of acquisition, the basis cost, i.e., the market price at the time of purchase, and any other suitable information associated therewith. If necessary, subroutine P218 scans or otherwise obtains market data MD related to primary investment 24a and adds market data MD into reference database 105c.

In a step 220, a subroutine P220 retrieves investment style K and performs on user terminal 102 a rule-based selection or any other suitable selection routine to determine one or more secondary investment objectives 26b that are the financial opposite of the primary investment objective 26a selected in step 214 for investment fund 20. Therein, the one or more secondary investment objectives match investment style K and may then be selected by the fund manager 12 from several choices. The one or more secondary investment objective 26b may instead or in addition be selected and/or presented as the most preferable choice by subroutine P220 in accordance with one or more rules established in step 210.

When more than one distinct secondary investment objective 26b exists, subroutine P220 may group the primary investment objectives 26a and determine one or more secondary investments 24b that match the same secondary investment objective.

For clarity, the acquisition of only one secondary investment 24b with respect to one secondary investment objective 26b is described herein. However, more than one secondary investment objective 26b may be met by acquisition and/or holding of a single secondary investment 24b. Similarly, a single secondary investment objective 26b may be met by the acquisition and/or holding of a plurality of secondary investments 24b.

In a step 222, a subroutine P222 executes on user terminal 102 and/or data processor 106 to acquire secondary investment 24b of step 220 in exchange for equity EQ.secondary. Subroutine P222 preferably, but not necessarily, executes one or more trading subroutines in an attempt to acquire the secondary investments through clearing exchange system 108 of national exchange 18 or any other suitable source for obtaining the one or more secondary investments.

The quantity of secondary investment 24b to obtain is determined by the equity EQ.primary of investment fund 20 spent to acquire primary investment 24a. For example, a primary investment 24a is a leveraged investment having a nominal value of 16 units of $250 and was acquired for $1600. Although, the primary investment has a nominal value of $4000, i.e., 16 units*$250/unit, it has an equity of $1600. Thus, to prevent the most problematic market risk R, investment fund being valued at zero or less than zero, it is only necessary to acquire secondary investment 24b so that it has a value of $1600. In accordance with one embodiment, the secondary investment 24b is a traded stock that has a secondary investment objective that is the financial opposite of the primary investment objective of primary investment 24b. Thus, $1600 worth of the stock is added to investment fund 20 using $1600 of equity EQ.secondary.

In another embodiment, secondary investment 24b is a particular leveraged investment that has a primary investment objective that is the financial opposite of the secondary investment objective of primary investment 24b. Thus, for example, secondary investment 24b may comprise 16 units of $100 nominal value per unit and was acquired at $300. Since secondary investment 24 has a secondary investment objective that is the financial opposite primary investment objective, the secondary investment is not likely to fail when the primary investment fails. Therefore, the $1600 nominal value of the secondary investment is equivalent to the $1600 equity of the primary investment. The quantity of secondary investment 24b to acquire is limited to the $300 equity EQ.secondary.

If the acquisition of secondary investment 24b is unsuccessful, subroutine P222 repeats step 222 to determine other secondary investments that the meet secondary investment objectives and attempts to acquire these secondary investments and then proceeds to step 224.

If successful, in step 224, a subroutine P224 executes on user terminal 102 and adds data associated with the acquisition of the one or more secondary investment 24b into fund holding database 105b. Such data may be the number of shares or holding units acquired, the date of acquisition, the basis cost, and any other suitable information associated therewith. If necessary, subroutine P224 scans or otherwise obtains market data MD related to secondary investment 24b and adds market data MD into reference database 105c.

After acquisition of primary investments 24a and/or also secondary investments 24b, the value of the investments changed due to the market conditions occurring during a period of time and a rebalancing phase, i.e., rebalancing cycle, comprising steps 226, 228, and 230 is performed. In accordance with one or more embodiments of the present invention, the rebalancing phase, i.e., rebalancing cycle, proceeds through three moments in time T.sub.1, T.sub.2, and T.sub.3 (in consecutive order) to manage one or more risks R using a risk-management method 200 implemented on a risk-management system 100. The moments in time may be any suitable period of time and may be a portion of a second or several years. For example, period of time T between T.sub.1 and T.sub.2 and/or between T.sub.2 and T.sub.3 is from close of one trading day to close of another trading day or may be less than one second.

In a step 226, at a point in time designated as T.sub.1, a subroutine P226 calculates on user terminal 102 and/or a data processor 106 the balance sheet of investment fund 20 after acquisition of primary investment 24a and secondary investment 26b that are an investment pair. This may include at least one or more of the following:
the value of all primary investments 24a,
the value of all secondary investments 24b,
liabilities
the net asset value NAV,
the change in the net asset value ΔNAV over any pre-determined period of time;
any redemptions;
any inflowing investment;
the nominal value of the primary investments;
the nominal value of the secondary investments;
the leverage factor of each primary investment;
the leverage factor of the sum of the primary investments.

The net asset value EQ.NAV is calculated as follows for each investment pair

EQ.NAV=((EQ.primary+EQ.secondary)−B−E+D+A)

Or more preferably, EQ.NAV=(EQ.primary+EQ.secondary)

and for the fund

EQ.NAV=((ΣEQ.primary+ΣEQ.secondary)−B−E+D+A)
Where
   NAV is the net asset value of investment fund 20;
   ΣEQ.primary is sum of the equity of all primary investments;
   ΣEQ.secondary is the sum of the equity of all secondary investments;
   B are the liabilities;
   E are the redemptions;
   D are new inflows of deposits;
   A are assets that are not primary investments or secondary investments; and
   B, E, D, and A are pro-rated and/or allocated for each investment when a calculation is made for other than the entire fund or more preferably are not considered when calculations are performed for investment pairs, i.e., EQ.NAV=EQ.primary+EQ.secondary.

Wherever, regardless of any calculation being performed in this application, B, E, D, and/or A are considered necessary, desired, and/or advantageous for each investment pair and/or each of primary investment or secondary investment, then it should be understood that EQ.primary and/or EQ.secondary include a full, a pro-rated and/or an allocated amount of one or more B, E, D, and/or A. In the alternative, B, E, D, and/or A may be allocated to the net asset values in a full, a pro-rated and/or an allocated amount as is necessary, desired, and/or advantageous.

The liabilities B may be operating expenses related to the fund, legal liabilities, management fees, and/or any other losses or reduction in assets which have not elsewhere been accounted. The assets A may be realized or unrealized gains, moneys owed, or any gains in assets which have not elsewhere been accounted.

A change in net asset value is calculated for each investment or as follows:

ΔNAV.T=(NAV.current−NAV.previous)/NAV.previous
Where
   ΔNAV.T is the change in the net asset value;
   NAV.current is current NAV value calculated as elsewhere and
   NAV.previous is the previous NAV value calculated as elsewhere and removed from the current by a period of time T.

The nominal net asset value is also calculated by subroutine 226 for each investment pair as follows:

NN.NAV=(HU.primary*PI.marketprice+EQ.secondary)

Therein, the nominal net asset value for the fund is calculated as follows:

NN.NAV=(HU.primary*PI.marketprice+EQ.secondary)

Therein, HU.primary is the number of holding units HU comprising the primary investment and PI.marketprice is the market price for each holding unit of the primary investment at time T.sub.1, i.e., the time at step 226, as determined by the market at the national exchange.

The actual leverage LF.actual is then calculated by subroutine P226 for each investment as follows:

LF.actual=(NN.NAV/EQ.NAV)

The actual leverage LF.actual is then calculated by subroutine P226 for the fund as follows:

LF.actual=(ΣNN.NAV/ΣEQ.NAV)

Primary investments are overleveraged when the actual leverage factor is greater than the target leverage factor LF.target and primary investments are underleveraged when the actual leverage factor is less than the target leverage factor LF.target. The fund's overall actual leverage factor may also be underleveraged or overleveraged depending if the actual leverage factor is less or greater than the target leverage factor, respectively.

In a step 228, subroutine P228 calculates the rebalance of investment fund 20 at a point in time designated as T. “Rebalance” is intended in this application for all purposes to be interpreted broadly and is defined as the acquisition of primary investments and/or secondary investments and/or sale primary investments and/or secondary investments to have the actual leverage factor of investment fund 20 be within the leverage factor range LFR, meet the target leverage factor, and/or have the sum of the nominal net value ΣNN.secondary of the secondary investments be at least as great as the sum of the equity ΣEQ.primary of the primary investments.

Therein, subroutine P228 retrieves investment style K from the database to obtain the leverage factor range and target leverage factor. Subroutine P228 then calculates whether the actual leverage factor LF.actual is within the leverage factor range. If it is, subroutine P228 stops processing and method 200 reverts to step 210.

Using a rule-based selection or any other suitable selection routine, subroutine P228 determines the amounts of primary investments 24a and/or secondary investments 24a to acquire and/or sell.

In certain situations, it may be necessary to acquire primary investments while also selling them or selling secondary investments while also acquire them.

If the actual leverage factor is outside the leverage factor range, subroutine P228 begins to rebalance the fund to be within the leverage factor range LFR, and more preferably at the target leverage factor LF.target.

To arrive at the leverage factor range LFR, or more specifically the target leverage factor LF.target, subroutine P228 calculates the amount of primary investments that are overleveraged, to sell as a rebalance trade to the national exchange 18, and the amount of primary investments, that are underleveraged to acquire as a rebalance trade from the national exchange 18. If equity is not available to rebalance, then requisite amounts of overleveraged and underleveraged primary investments are sold by reducing the entire investment fund.

Therein, subroutine P228 calculates the amount of a rebalance trade RBTR to redeem or acquire for each investment as follows:

RBTR=(EQ.NAV*LF.target−NN.NAV)

The rebalance calculation determines that the fund needs to add nominal exposure to the primary investments that have moved positively and subtract nominal exposure from primary investment that have moved negatively. In other words, if the RBTR for an investment is negative, the fund is overleveraged with respect to that investment; and a rebalance trade selling an amount of the investment equivalent to the negative amount must be attempted. If the RBTR for an investment is positive, the fund is underleveraged with respect to that investment; and a rebalance trade equivalent to the positive amount acquiring the investment must be attempted.

Thus, in a step 230, subroutine P230 executes one or more trading subroutines to affect the rebalancing trades. Upon execution of the rebalance trades, a period of time will have expired and the point time will be T.sub.3 at which the fund comprises an actual leverage factor LF.actual, which matches the target leverage factor LF.target and is within the leverage factor range LFR.

Since the market continues to trade and market prices evolve during the rebalancing, time T.sub.3 is equivalent to time T.sub.1 in the rebalancing phase, i.e., rebalancing cycle. While the rebalancing phase, i.e., rebalancing cycle, has occurred, investment fund 20 preferably has repeated step 210 through step 224 and acquired additional new primary investments, which are then rebalanced in steps 226, 228, and 230 along with the primary investments already in the investment fund.

Thus, the rebalancing phase, i.e., rebalancing cycle, has in accordance with one or more embodiments of the present invention proceeded through three moments in time T.sub.1, T.sub.2, and T.sub.3 (in consecutive order) to manage one or more risks R using a risk-management method 200 implemented on a risk-management system 100.

If a primary investment that is present in the fund is to be sold, in step 210 it is designated as such and it is omitted from one or more or all calculations in the rebalancing phase, i.e., rebalancing cycle, if the primary investment has not already been sold prior to method 200 reaching the rebalancing cycle.

### Example 1

FIGS. 3a-3d are spreadsheets illustrating an investment fund 20 in accordance with one or more embodiments of the present invention proceeding through three moments in time, T.sub.1, T.sub.2, and T.sub.3 (in consecutive order) in one rebalancing phase, i.e., rebalancing cycle, of managing one or more risks R using a risk-management method 200 implemented on a risk-management system 100.

Investment fund 20 has a total portfolio after steps 210 through step 224 as illustrated in FIG. 3a. Therein, investment fund 20 started with primary investments and secondary investments each equaling zero, but with a cash equity position of $5004 and no liabilities. The operating costs are assumed to be zero.

In step 214, an investment style K having a target leverage factor LF.target of 4 and a certain primary investment objective and secondary investment objective were selected by subroutine 214.

In step 216, primary investments 24a comprising investments A-D matching the primary investment objective were acquired through a national exchange. That is, for example, primary investment A comprises 100 holding units and was acquired at $40 per holding unit. Because the primary investments were leveraged investments, the nominal value NN.primary is $20,000. Thus, in this example, investment fund 20 is comprised of 4 investments. Each investment has a leverage factor LF at any point in time and that is used to manage risk.

In step 218, subroutine P218 adds data associated with the investments A-D into fund holding database 105b.

In step 220, investment style K is retrieved and a secondary investment objective matching investment style K is selected by subroutine 220.

In step 222, subroutine P222 executes and acquires secondary investment 24b comprising investments A.opposite through D.opposite (indicated also has −A through −D) and in exchange for $4 of the cash equity. The secondary investment has a secondary investment objective that is opposite the primary investment objective of primary investment 24a. Investments A.opposite through D.opposite are leveraged investments, and thus, the secondary equity EQ.secondary required to a nominal value NN.secondary equal to the equity EQ.primary of the primary investment can be greatly minimized.

If, for example, investment A.opposite was a cash position, which is not a leveraged investment, the secondary equity EQ.secondary required to match the primary equity EQ.primary of investment A would be $1000 cash. The cash position would almost always require a greater equity EQ.secondary than a leveraged investment. In certain circumstances, the cash position and the leveraged investment would be equivalent as, for example, when the leveraged investment is near its expiry or the event underlying the leveraged investment is a factual certainty. Thus, in accordance with one or more embodiments of the present invention the secondary equity is preferably a leveraged investment.

In this example, the secondary investment is an out-of-the-money strike at 25%. An out of the money strike may be one of two options: a call option having a strike price that is higher than the market price of the underlying asset or a put option with a strike price that is lower than the market price of the underlying asset. The value of an out of the money option erodes quickly with time as it gets closer to expiry. However, in this context, such a secondary investment provides a very cost effective way to use minimum equity on the secondary investment, but maximum equity on the primary investment.

The total equity net asset value EQ.NAV when a fund is initially set-up is calculated during step 212. Therein, the net asset value EQ.NAV of the fund is calculated as follows:

$$\begin{matrix}EQ . NAV = & ( ( Σ EQ . primary + Σ EQ . secondary ) - \\ & liabilities - redemptions + inflows ) \\ = & ( ( 5000 + 4 ) - 0 - 0 + 0 ) \\ = & \$5004\end{matrix}$$

Therein, the net asset value of each investment pair, i.e., A and A.opposite, is calculated as follows:

EQ.NAV=(EQ.primary+EQ.secondary)

Throughout Example 1, liabilities, redemptions and inflows other than the $5004 equity at point in time designated T.sub.1 is assumed to be zero and in accordance with one or more embodiments of the present invention when data is calculated for each investment pair, the liabilities, redemptions and inflows are ignored and allocated to the fund as a whole.

That is primary investments 24a have a total equity EQ.primary of $5000. That is of the $5004 equity EQ.NAV in the investment fund, $5000 was used to purchase the primary investments. The secondary investments 24b have a total nominal value of $5000 that is available to manage risk R associated with primary investments 24a. To manage the risk, only $4 of the equity in investment fund 20 was used.

The result of the investments i.e., the final estimated net asset value, is the nominal net asset value NN.NAV for investment fund 20

$$\begin{matrix}NN . NAV = & ( Σ ( HU . primary * PI . marketprice ) + EQ . secondary ) - \\ & liabilities - redemptions + inflows ) \\ = & ( ( ( 100 * 40 ) + ( 100 * 60 ) + ( 100 * 20 ) + ( 100 * 80 ) ) \\ & + 4 ) - 0 - 0 + 0 \\ = & \$20 \text{,} 004\end{matrix}$$

Thus, a $5004 fund is controlling at an initial time, i.e., time T.sub.1, $20,004.

In step 224, subroutine P224 adds data associated with the investments A.opposite through D.opposite into fund holding database 105b.

After acquisition of primary investments 24a and/or also secondary investments 24b, the value of the investments changed due to the market conditions occurring during a period of time and the point in time T.sub.2 as illustrated in FIG. 3b and a rebalancing phase, i.e., rebalancing cycle, comprising steps 226, 228, and 230 is performed.

In step 226, the equity of the now changed primary investments A-D are added. Similarly, the nominal value and the equity of the secondary investments A.opposite through D.opposite have changed.

The net asset value is calculated by adding the equity of the primary investment and the equity of the secondary investment in investment fund 20.

The net asset value is now calculated by subroutine P226, as follows:

$$\begin{matrix}EQ . NAV = & ( ( Σ EQ . primary + Σ EQ . secondary ) - \\ & liabilities - redemptions + inflows ) \\ = & ( ( 5200 + 4 ) - 0 - 0 + 0 ) \\ = & \$5 \text{,} 204\end{matrix}$$

The result of the investments at time T.sub.2 is that for investment fund 20

$$\begin{matrix}NN . NAV = & ( Σ ( HU . primary * PI . marketprice ) + EQ . secondary ) - \\ & liabilities - redemptions + inflows ) \\ = & \$20 \text{,} 204\end{matrix}$$

The actual leverage LF.actual is then calculated by subroutine P226 for each investment as follows:

LF.actual=(NN.NAV/EQ.NAV)

The actual leverage LF.actual is then calculated by subroutine P226 for investment fund as follows:

$$\begin{matrix}LF . actual = ( NN . NAV \text{/} Σ EQ . NAV ) \\ = ( 20204 \text{/} 5204 ) \\ = 3.88\end{matrix}$$

In FIG. 3b, investments A and C are overleveraged, i.e., the actual leverage factor LF.actual is greater than the target leverage factor LF.target of 4 and investments B and D are underleveraged, i.e., the actual leverage factor is less than the target leverage factor LF.target of 4. The fund's overall actual leverage factor is less than the target leverage factor LF.target 4.

In step 228, at time T.sub.2, subroutine P228 retrieves investment style K from the database and determines that that the actual leverage factor LF.actual is limited to a leverage factor range LFR of 3.9-4.1 and a target leverage factor LF.target. Thus subroutine P228 rebalances the fund to be within the leverage factor range LFR, and more preferably at the target leverage factor LF.target of 4.

To arrive at the leverage factor range LFR of 3.95-4.4, or more specifically the target leverage factor LF.target of 4, subroutine P228 calculates the amount of primary investments that are overleveraged, e.g., primary investments A and C, to sell as a rebalance trade to the national exchange 18, and the amount of primary investments, that are underleveraged e.g., primary investments B and D, to acquire as a rebalance trade from the national exchange 18. If equity is not available to rebalance, then overleveraged and underleveraged primary investments are sold by reducing the entire investment fund.

FIG. 3c illustrates the rebalancing calculation. Therein, subroutine P228 calculates the amount of a rebalance trade RBTR to redeem or acquire for each investment as follows:

RBTR=(EQ.NAV*LF.target−NN.NAV)

Herein, investment fund 20 is underleveraged due to the overall combined move of all the investments positively. The rebalance calculation determines that the fund needs to add nominal exposure to the primary investments that have moved positively and subtract nominal exposure from primary investment that have moved negatively.

Specifically, primary investments A and C have a rebalance trade of $124 worth of primary investments A and C sold on national exchange 18 and primary investments B and D have a rebalance trade of $356 and $476 in primary investments B and D, respectively to be acquired from national exchange 18.

Thus, in step 230, subroutine P230 executes one or more trading subroutines to affect the rebalancing trades. Upon execution of the rebalance trades, a period of time will have expired and the point time will be T.sub.3 at which the fund comprises an actual leverage factor LF.actual of 4, which matches the target leverage factor LF.target and is within the leverage factor range LFR.

Since the market continues to trade and market prices evolve during the rebalancing, time T.sub.3 is equivalent to time T.sub.1 in the rebalancing phase, i.e., rebalancing cycle. While the rebalancing phase has occurred, investment fund 20 preferably has repeated step 210 through step 224 and acquired additional new primary investments, which are then rebalanced in steps 226, 228, and 230 along with the primary investments A-D in the investment fund.

Herein, rebalancing phase, i.e., rebalancing cycles repeat in fractions of seconds to maintain a managed exposure to risk R at all times and method 200 also cycles.

### Example 2

FIG. 4 is a spreadsheet illustrating an investment fund 20 in accordance with one or more embodiments of the present invention proceeding through three moments in time T.sub.1, T.sub.2, and T.sub.3 (in consecutive order) in one rebalancing phase, i.e., rebalancing cycle, of managing one or more risks R using a risk-management method 200 implemented on a risk-management system 100.

Investment fund 20 has a total portfolio after steps 210 through step 224 as illustrated in FIG. 4. Therein, the primary investment 24b comprises a single primary investment A and a single secondary investment A.opposite (also designated as −A) and has a target leverage factor LF.target of 4, which at point in time T.sub.1 is the actual leverage factor LF.actual.

At time T.sub.2, the market has moved and primary investment A has positive movement M; this has affected the leverage of the fund. Thus, at time T.sub.2, a rebalancing phase, i.e., rebalancing cycle, must be undertaken to manage risk R. This is accomplished by bringing the primary investment into the target leverage factor. A specific leverage factor is preferred, since only one primary investment is disposed in fund 20.

Therein, the fund is underleveraged due to the move of the primary investment moving positively. The rebalance calculation determines that the fund needs to add nominal exposure to the primary investment that has moved positively. Upon execution of the rebalance at time T.sub.3, the fund has been brought back to target leverage factor of 4 and moves into the next rebalancing phase, i.e., rebalancing cycle.

### Example 3

FIG. 5 is a spreadsheet illustrating an investment fund 20 in accordance with one or more embodiments of the present invention proceeding through three moments in time T.sub.1, T.sub.2, and T.sub.3 (in consecutive order) in one rebalancing phase, i.e., rebalancing cycle, of managing one or more risks R using a risk-management method 200 implemented on a risk-management system 100.

Investment fund 20 has a total portfolio after steps 210 through step 224 as illustrated in FIG. 4. Therein, the primary investment 24b comprises a single primary investment A and a single secondary investment A.opposite (also designated as −A) and has a target leverage factor LF.target of 4, which at point in time T.sub.1 is the actual leverage factor LF.actual.

At time T.sub.2, the market has moved and primary investment A has a negative movement M of more than 25%; this has affected not only the leverage of the fund but used up the fund protection. A 25% movement in value is the equivalent of a leverage factor 4. Thus, at time T.sub.2, a rebalancing phase, i.e., rebalancing cycle, must be undertaken to manage risk R. This is accomplished by bringing the primary investment into the target leverage factor. A specific leverage factor is preferred, since only one primary investment is disposed in fund 20.

Herein, investment fund 20 is overleveraged and has an actual leverage factor 57 due to the negative movement M of the primary investment 24a. In step 228, subroutine P228 determines that the fund needs to decrease nominal exposure to primary investment 24a, which has moved negatively. Additionally, because of the protection in place the secondary investment 24b is sold to rebalance the holding with a new strike that is a 25% out of the money strike. Upon execution of the rebalance, at time T.sub.3, the fund has been brought back to an actual leverage factor of 4 and the new secondary investment is out of the money 25% and moves into the next rebalancing phase, i.e., rebalancing cycle.

While the present invention has been described at some length and with some particularity with respect to the several described embodiments, it is not intended that it should be limited to any such particulars or embodiments or any particular embodiment, but it is to be construed to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A system for managing risk in an investment fund; the system comprising:
at least one computer
executing a first selection to determine a primary investment in accordance with a primary investment objective;
executing a second selection to determine a secondary investment objective that is a financial opposite of the primary investment objective;
executing a third selection to determine a secondary investment in accordance with the secondary investment objective;
performing a rebalancing cycle comprising
(i) at a first point in time,
(1) calculating a net asset value of the investment pair according to formula EQ.NAV=(EQ.primary+EQ.secondary);
(2) calculating a nominal net asset value according to formula NN.NAV=(HU.primary*PI.market price)+EQ.secondary
(3) calculating an actual leverage factor LF.actual according to formula LF.actual=(NN.NAV/EQ.NAV);
(ii) at a second point in time, the second point in time being subsequent in time to the first point in time, calculating a rebalance trade RBTR of the primary investment according to formula RBTR=(EQ.NAV*LF.target−NN.NAV);
wherein
EQ.primary is an equity of the primary investment;
EQ.secondary is an equity of the secondary investment;
HU.primary is a number of holding units of the primary investment; and
PI.marketprice is a market price per holding unit of the primary investment.

2. The system of claim 1, wherein the computer comprises at a third point in time, the third point in time being subsequent in time to the second point in time, executing a trading subroutine to execute the rebalance trade.

3. The system of claim 2, further comprising a computer associated with a national clearing exchange for executing a rebalance trade.

4. The system of claim 1, further comprising a compliance database.

5. The system of claim 1, further comprising a fund holding database.

6. The system of claim 1, wherein the investment fund comprises an investment style.

7. The system of claim 1, further comprising a data center.

8. A non-transitory media comprising:
a computer program executing on a computer for
executing a first selection to determine a primary investment in accordance with a primary investment objective;
executing a second selection to determine a secondary investment objective that is a financial opposite of the primary investment objective;
executing a third selection to determine a secondary investment in accordance with the secondary investment objective;
performing a rebalancing cycle comprising
(i) at a first point in time,
(1) calculating a net asset value of the investment pair according to formula EQ.NAV=(EQ.primary+EQ.secondary);
(2) calculating a nominal net asset value according to formula NN.NAV=(HU.primary*PI.market price)+EQ.secondary;
(3) calculating an actual leverage factor LF.actual according to formula LF.actual=(NN.NAV/EQ.NAV);
(ii) at a second point in time, the second point in time being subsequent in time to the first point in time, calculating a rebalance trade RBTR of the primary investment according to formula RBTR=(EQ.NAV*LF.target−NN.NAV);
wherein
EQ.primary is an equity of the primary investment;
EQ.secondary is an equity of the secondary investment;
HU.primary is a number of holding units of the primary investment; and
PI.marketprice is a market price per holding unit of the primary investment.

9. The non-transitory media of claim 8, further comprising (c) at a third point in time, the third point in time being subsequent in time to the second point in time, executing on a computer a trading subroutine to execute the rebalance trade.

10. A method of managing risk in an investment fund,
the investment fund comprising an investment pair, the investment pair comprising a primary investment and a secondary investment that is the financial opposite of the first investment, the investment fund comprising a target leverage factor LF.target.
the method comprising the steps of:
(a) at a first point in time,
(i) calculating by a computer a net asset value of the investment pair according to formula EQ.NAV=(EQ.primary+EQ.secondary);
(ii) calculating a nominal net asset value according to formula NN.NAV=(HU.primary*PI.market price+EQ.secondary);
(iii) calculating by a computer an actual leverage factor LF.actual according to formula LF.actual=(NN.NAV/EQ.NAV);
(b) at a second point in time, the second point in time being subsequent in time to the first point in time, calculating by a computer of a rebalance trade RBTR of the primary investment according to formula RBTR=(EQ.NAV*LF.target−NN.NAV);
wherein
EQ.primary is an equity of the primary investment;
EQ.secondary is an equity of the secondary investment;
HU.primary is a number of holding units of the primary investment; and
PI.marketprice is a market price per holding unit of the primary investment.

11. The method of claim 10, further comprising a step (c) at a third point in time, the third point in time being subsequent in time to the second point in time, executing on a computer a trading subroutine to execute the rebalance trade.

12. The method of claim 11, wherein steps (a), (b) and (c) comprise a single rebalancing cycle, and a plurality of rebalancing cycles are performed consecutively after each other.

13. The method of claim 11, wherein the rebalance trade is executed on a national clearing exchange.

14. A method of managing risk in an investment fund, the investment fund comprising a target leverage factor LF.target, the method comprising the steps of:
(a) executing a first selection on a computer to determine a primary investment in accordance with a primary investment objective;
(b) executing a second selection on a computer to determine a secondary investment objective that is a financial opposite of the primary investment objective;
(c) executing a third selection on a computer to determine a secondary investment in accordance with the secondary investment objective;
(d) performing a rebalancing cycle comprising
(i) at a first point in time,
(1) calculating by a computer a net asset value of the investment pair according to formula EQ.NAV=(EQ.primary+EQ.secondary);
(2) calculating by a computer a nominal net asset value according to formula NN.NAV=(HU.primary*PI.market price+EQ.secondary);
(3) calculating by a computer an actual leverage factor LF.actual according to formula LF.actual=(NN.NAV/EQ.NAV);
(ii) at a second point in time, the second point in time being subsequent in time to the first point in time, calculating by a computer of a rebalance trade RBTR of the primary investment according to formula RBTR=(EQ.NAV*LF.target−NN.NAV);
wherein
EQ.primary is an equity of the primary investment;
EQ.secondary is an equity of the secondary investment;
HU.primary is a number of holding units of the primary investment; and
PI.marketprice is a market price per holding unit of the primary investment.

15. The method of claim 14, further comprising a step (iii) at a third point in time, the third point in time being subsequent in time to the second point in time, executing on a computer a trading subroutine to execute the rebalance trade.

16. The method of claim 15, wherein step (i) is repeated after step (iii).
